(19) United States
(12) Patent Application Publication
(10) Pub. No.: US 2013/0260344 A1
(43) Pub. Date: Oct. 3, 2013

(54) Method and System for Evaluating Driving Performance

(71) Applicant: GREENROAD DRIVING TECHNOLOGIES, LTD., Beit-Dagan (IL)

(72) Inventors: Oren Musicant, Tel-Aviv (IL); Ofer Nissim Raz, Tel-Aviv (IL)

(73) Assignee: GREENROAD DRIVING TECHNOLOGIES, LTD., Beit-Dagan (IL)

(21) Appl. No.: 13/828,726

(22) Filed: Mar. 14, 2013

(30) Foreign Application Priority Data
Apr. 2, 2012 (IL) 218979

(51) Int. Cl. G09B 19/16

(52) U.S. Cl. CPC G09B 19/167
USPC 434/65

(57) ABSTRACT

A method and system are provided for evaluating driving performance of a driver according to one or more of at least two different performance classes, wherein each performance class relates to a different aspect of driving performance than the others. The method comprising the steps of: identifying a plurality of driving events in a driving session, wherein each of the driving events is associated with indicators characterizing the respective driving event; retrieving values for indicators associated with the respective driving events identified; providing a plurality of pre-defined coefficients that enable adapting the retrieved indicators' values to one of the at least two different performance classes; and based on the values retrieved for the indicators associated with the identified driving events and the plurality of pre-defined coefficients, evaluating a driving performance that is compatible with one or more of the at least two different performance classes.

### CROSS-REFERENCE TO RELATED APPLICATIONS

This application claims the benefit of priority under 35 USC 119 to Israel Patent Application No. 218979, filed Apr. 2, 2012, the entire contents of which are hereby incorporated by reference herein in its entirety for all purposes as if fully set forth herein.

### TECHNICAL FIELD

The present disclosure generally relates to monitoring systems installed in vehicles and methods for using them, and more particularly to techniques for evaluating the driver's driving performance.

### BACKGROUND

In recent years an increasing number of vehicles are being equipped with monitoring systems that are capable of supervising the way a vehicle is being driven. Most monitoring systems capture real-time data and provide the driver of the vehicle and/or a fleet manager with an objective evaluation of the driving performance. Most monitoring systems known in the art are used to confirm whether the driver drives safely by facilitating the collection of qualitative and quantitative information related to factors that are known as ones that contribute to the occurrence of road accidents. In addition, monitoring systems may also be used to analyze other aspects of the driver's driving performance such as fuel consumption, driving habits, eco driving and more. Our published US patent application No. 20110166773 which is hereby incorporated by reference in its entirety, is one example which discloses ways for evaluating vehicle's fuel consumption efficiency.

Most of the monitoring systems described in the art use a scoring mechanism to evaluate the driver performance. Such a scoring mechanism is typically a set of rules implemented over data collected from the driver's driving history (e.g. measurements taken by sensors installed in the vehicle being driven).

One typical example of a monitoring system which uses the collected data to provide driving performance risk scores is described in US Patent Application No. 20100030586. Another example of a monitoring system has been extensively described and exemplified in our U.S. Pat. No. 7,389,178 which is hereby incorporated by reference in its entirety.

However, one of the disadvantages of the existing systems is that they evaluate the driver's driving performance based on one aspect of his/her driving (e.g. how safe is his/her driving) and are unable to provide an overall view of the driving performance. Furthermore, it should be noted that when certain driving events take place, they may have a different impact on the evaluation of different aspects of driving performances. For example, taking a curve in a dangerous way will have a much more adverse effect upon the driver's safety performance than upon the driver's economical driving performance, whereas driving at high speed will have a more adverse effect upon the driver's economical driving performance than upon the driver's safety performance. Therefore, even if the scores of the events that are obtained while exhibiting a certain driving performance are further used to evaluate a different aspect of the driver's driving, using these scores will usually not be helpful in obtaining an evaluation for the different class (type) of driving performance.

The present invention seeks to overcome these problems.

### SUMMARY OF THE DISCLOSURE

The disclosure may be summarized by referring to the appended claims.

It is an object of the present invention to provide a driving evaluation mechanism that enables evaluating different classes of driving performances, each relating to a different aspect of the driver's driving.

It is another object of the present invention to provide a driving evaluation mechanism that enables evaluating the driver's overall driving performance while taking into consideration different aspects of his/her driving skills.

Other objects of the invention will become apparent as the description of the invention proceeds.

According to a first embodiment, a method is provided for evaluating driving performance of a driver according to one or more of at least two different performance classes, wherein each performance class relates to a different aspect of driving performance than the others. The method comprising:

identifying a plurality of driving events in one or more driving sessions, wherein each of the driving events is associated with one or more indicators characterizing the respective driving event;

retrieving values for indicators associated with the respective driving events identified, preferably, at least some of the indicators' values are retrieved from one or more sensors located within a vehicle being driven by the driver whose driving performance should be evaluated;

providing a plurality of pre-defined coefficients that enable adapting the retrieved indicators' values to one of the at least two different performance classes; and

based on the values retrieved for the indicators associated with the identified driving events and the plurality of pre-defined coefficients, evaluating a driving performance that is compatible with one or more of the at least two different performance classes.

In the following description, the term “driving event” as used herein throughout the specification and claims, is used to denote any pattern in the data collected by one or more sensors located in the vehicle being driven during a driving session, which can be identified for example based on comparison with a driving event library, or by any other method known in the art per se. Examples of driving events types are members of a group consisting of: braking, accelerating, braking into turn, accelerate into turn, accelerate while in turn, sudden brake in turn, turning, accelerate while in turn, braking while in turn, accelerate while exiting turn, braking while exiting turn, U turn, lane changing, bypass, lane handling, backing, idling and speeding. Each type of driving event may typically be characterized by a certain pattern in the data collected.

The term “driving session” as used herein throughout the specification and claims, describes a period of time that begins when the driver starts the engine of the vehicle at a certain location (e.g. at point A), and ends when the driver turns off the engine of the vehicle at another location (e.g. at point B). Obviously it encompasses cases where the vehicle's engine is turned on throughout the whole period, but in the alternative, a driving session should be understood also to encompass a case where the driver turns off the engine before reaching his destination (at point B) and then turns it again to resume driving. However, as will be appreciated by those skilled in the art, the latter case may be referred to as one driving session or as two consecutive driving sessions, as the case may be. Typically, a plurality of driving events may be identified during every driving session. Preferably, a driving session comprises a plurality of identified driving events among which at least two driving events are each of a type being different from the type that the other belongs.

The term “indicator”, as used herein throughout the specification and claims, refers to a parameter (variable) that represents either a specific element of a driving event or a parameter that represents the type of a specific driving event, or of a driving session, where in the latter case the indicator is not necessarily associated with a specific driving event, and may relate to characteristics of a driving session, such as average speed throughout a driving session (or part thereof). The value of an indicator may be a direct result of one or more measurements carried out by the sensors system, e.g. maximum speed in a turning event, maximum speed in a given driving session, and the like. In addition, the value of an indicator may also be derived from an analysis of data retrieved from the sensors' system, e.g. average speed during a lane changing event, average speed during a given driving session, etc. In the alternative, an indicator may represent how well a specific driving event was preformed, so that for each type of a driving event, there may be one or more respective indicators.

Examples of such indicators are members of a group that consists of: driving event indicator, maximum speed indicator, speed variance indicator, average speed indicator, acceleration variance indicator, average acceleration indicator, time above a predefined speed limit indicator, time spent while driving in eco speed indicator, speed variability indicator, sum over accelerating scores indicator, sum over braking scores indicator, braking indicator, accelerating indicator, speed during a driving event exceeding ratio indicator (i.e. the maximum speed recorded during the driving event divided by speed limit minus 1), idling time indicator, driving session average speed indicator, driving session speed variance indicator, driving session average acceleration indicator, driving session acceleration variance indicator, driving session speed exceeding ratio indicator, driving session idling time indicator, braking into turn indicator, accelerate into turn indicator, accelerate while in turn indicator, sudden brake in turn indicator, turning indicator, accelerate while in turn indicator, braking while in turn indicator, accelerate while exiting turn indicator, braking while exiting turn indicator, lane change indicator, bypass indicator, lane handling indicator, and the like.

The term “aspect of driving”, as used herein throughout the specification and claims, is used to describe one characteristic of the driving of a driver. An answer for the simple question “is Bob a good driver?” is not so simple to provide, because there are several aspects that relate to Bob's driving, e.g. Bob may drive very safely but not so economically. The present invention demonstrates how to determine scores of a number of driving performance classes, where each of these classes is associated with a different driving aspect, and/or how to determine one combined score that takes into accounts the individual scores obtained for their respective driving performances.

By still another embodiment, the pre-defined coefficients are capable of adapting the retrieved indicators' values to one of the at least two different performance classes, based upon the significance of the type of a driving event associated with the indicators being adapted, to the respective driving performance class.

According to another embodiment, the method further comprising a step of dividing the indicators and/or the values thereof into groups, wherein at least one of these groups contains only one or more indicators and/or their values that are associated with one type of the identified driving events, and deriving a representative value (e.g. an average value or an aggregated value) for each of the indicators associated with the at least one group, wherein each representative value is derived based on the values of respective indicators included in that at least one group.

In accordance with another embodiment, each of the at least two different classes of driving performance is associated with a corresponding set of a plurality of pre-defined coefficients, so that the values of the indicators associated with driving events of different types can be adjusted in accordance with the significance of the respective type of a driving event onto the performance class associated with the driving performance that should be evaluated (e.g. by providing different weights for the score of each driving performance class).

By yet another embodiment, one of the at least two different performance classes is safety and another one of the at least two different performance classes is economical driving (e.g. fuel consumption).

According to still another embodiment, the driving performance of the driver is an overall driving performance derived from the evaluation of two or more different performance classes. Preferably, each of the two or more different performance classes is associated with a coefficient relative to the significance of that performance in the evaluation of the driver's overall driving performance.

By yet another embodiment, the driving performance of the driver is evaluated for a pre-determined period of time (e.g. on a weekly/monthly basis, for the last seven days, etc.)

In accordance with still another embodiment, the driving performance of the driver is evaluated for a pre-determined road section (e.g. for last 100 KM, for a road segment specified between point A to point B, etc.)

According to another embodiment, the value of at least one of the plurality of the pre-determined coefficients is affected by the specific vehicle being driven by the driver (e.g. type of the vehicle, model of the vehicle, etc.).

According to another embodiment, at least some of the at least some of the plurality of pre-determined coefficients are associated with more than one value, and the value to be used is selected based upon at least one external factor which is not dependent on the driver's driving performance. Such factors may be for example, weather condition (which may affect differently the pre-defined value of the coefficient when applied for evaluating the driver's safety performance and when applied for evaluating the performance of the driver's fuel consumption performance), traffic conditions (which may have adverse effect upon the driver's fuel consumption and different effect on the safety of his driving), speed limit, etc.

In accordance with yet another embodiment, the step of retrieving values for indicators associated with the respective driving events identified further comprises retrieving values for indicators that are associated with the one or more driving sessions but are not associated with any of the identified driving events.

According to another aspect, there is provided a system for evaluating driving performance of a driver according to one or more of at least two different performance classes, wherein each performance class relates to a different aspect of driving performance than the others, the system comprising:
a plurality of sensors located within a vehicle being driven by the driver, operative to collect data that relates to the performance of a driver during one or more driving sessions; and
a processor adapted to:
   identify a plurality of driving events during one or more driving sessions from among the data collected, wherein each of the driving events is associated with one or more indicators characterizing the respective driving event, and wherein the plurality of driving events identified comprises driving events of at least two different types;
   based on the data collected by one or more of the plurality of sensors, retrieve values for indicators associated with each of the respective driving events identified;
   based on the values retrieved for the indicators associated with the identified driving events, and a plurality of pre-defined coefficients used for adapting the retrieved indicators' values to one of the at least two different performance classes, evaluate a driving performance that is compatible with one or more of the at least two different performance classes.

By still another embodiment of this aspect, the processor is configured to apply the pre-defined coefficients in order to adapt the retrieved indicators' values to one of the at least two different performance classes, based upon the significance of the type of a driving event associated with the indicators being adapted, to the respective driving performance class.

According to another embodiment of this aspect, the processor is further configured to divide the indicators and/or the values thereof into groups (which may also be referred to as categories), wherein at least one of these groups contains one or more different indicators and/or their values associated with one type of the identified driving events, and to derive therefrom a representative value for each of the indicators associated with the at least one group, wherein each representative value is derived based on values of respective indicators included in that at least one group.

By yet another embodiment, each of the at least two different classes of driving performance is associated with a corresponding set of a plurality of pre-defined coefficients, so that the values of the indicators associated with driving events of different types can be adjusted in accordance with the significance of the respective type of a driving event onto the performance class associated with the driving performance that should be evaluated.

In accordance with still another embodiment, the driving performance of the driver is an overall driving performance which is evaluated according to two or more different performance classes.

By yet another embodiment, each of the two or more different performance classes is associated with a coefficient relative to the significance of that driving performance in the evaluation of the driver's overall driving performance.

According to another aspect, there is provided a computer program product encoding a computer program stored on a non-transitory computer readable storage medium for executing a set of instructions by a computer system comprising one or more computer processors for carrying out a method for evaluating a driving performance of a driver according to one or more of at least two different performance classes, wherein each performance class relates to a different aspect of driving performance than the others, the method comprising: identifying a plurality of driving events in one or more driving sessions, wherein each of the driving events is associated with one or more indicators characterizing the respective driving event, and wherein the plurality of driving events identified comprises driving events of at least two different types; retrieving values for indicators associated with the respective driving events identified; and based on the values retrieved for the indicators associated with the identified driving events, and a plurality of pre-defined coefficients operative for adapting said retrieved indicators' values to one of the at least two different performance classes, evaluate a driving performance that is compatible with one or more of said at least two different performance classes.

According to another embodiment of this aspect, the pre-defined coefficients are operative to adapt the retrieved indicators' values to one of the at least two different performance classes, based upon the significance of the type of the driving event associated with the indicators being adapted, to the respective driving performance class.

In accordance with still another embodiment of this aspect, the driving performance of the driver is an overall driving performance which is evaluated according to two or more different performance classes.

### BRIEF DESCRIPTION OF THE DRAWINGS

A better understanding of the present invention is obtained when the following non-limiting detailed description and examples are considered in conjunction with the accompanying drawings wherein:

FIG. 1—is a flow chart which demonstrates several embodiments of the invention; and

FIG. 2—is a diagram illustrating the components of a scoring mechanism.

### DETAILED DESCRIPTION

In the following description, for the purposes of explanation, numerous specific details are set forth in order to provide a thorough understanding of the present invention. It should be apparent, however, that the present invention may be practiced without these specific details.

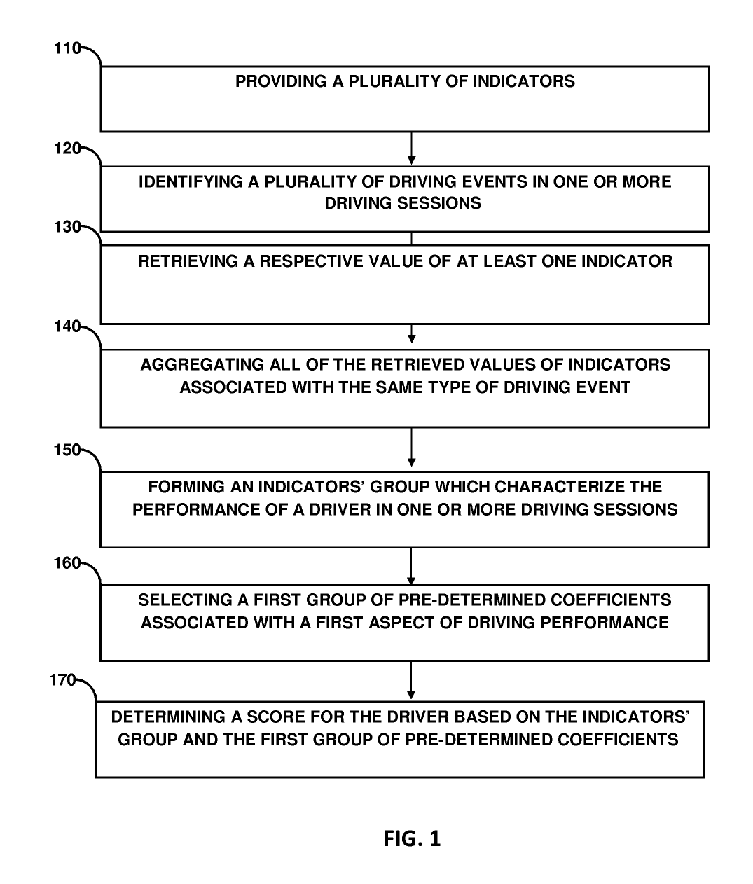

The steps of the method provided by an embodiment of the invention are demonstrated in the flow chart presented in FIG. 1. The first step (110) is providing a plurality of indicators for representing the driving events that will be identified during the driver's driving that is about to be evaluated. The plurality of indicators comprises the parameters that represent either one or more specific elements of a driving event, or the parameter(s) that represent(s) the type of a driving event (i.e. that represent(s) all events of that type). For example, some of the plurality of indicators may be associated with the type of a certain driving event (and will be the same indicators for all driving events of that type), while other indicators may relate to certain statistical parameters that are associated with a driving session.

Next, in step (120) a plurality of driving events is identified based on data collected from the vehicle's sensors during one or more driving sessions. The identification may be carried out according to any known method in the art. One such method has been described in our U.S. Pat. No. 7,389,178.

In step (130), for each of the identified driving events, the value(s) of the respective one or more indicators associated with the type of the identified driving event, is/are retrieved. The driving events are then grouped in accordance with their respective types (step 140), e.g. each group comprises all of the identified events of the same type, and then the indicators' values that are associated with all the events comprised in some (or all) of these groups, are aggregated and/or averaged (step 150), and a representative value is provided for each of the indicators associated with the type of driving event of such a group.

Next, based on the aspect (class) of driving performance which is to be evaluated, a first group of pre-determined coefficients is selected (step 160). This first group of pre-determined coefficients is associated with one of the classes of driving performances, even though some of the pre-determined coefficients that belong to the first group may be also applicable to some of the pre-determined coefficients that belong to another group. In some cases, typically where there are more than two classes of driving performances to evaluate the driver's performance, two classes may share most, (or even all for classes being impacted similarly by the various events), of the pre-determined coefficients associated with other class. Essentially, a group of pre-determined coefficients comprises one or more coefficients for each type of indicator (or for each type of event, where the latter may be associated with more than one indicator), and one typical way of using these pre-determined coefficients is by multiplying the value of the indicators associated with a certain driving event that was identified, with their corresponding coefficients having pre-defined values that match the class of driving performance which needs to be evaluated. This way, the coefficients provide a certain weight to any given indicator (or a representative value thereof in case indicators of the same type are first grouped together), where the weight depends upon the significance of the driving indicator (or driving event) to the class of driving performance which needs to be evaluated. For example, the values of the indicators associated with the event of changing lane while taking a turn may be multiplied by a coefficient of a high value when the driving performance to be evaluated is safety of the driving performance, whereas the very same indicators' values will be multiplied by a coefficient of a low value when the driving performance to be evaluated is economical driving performance, as such an event is rather unlikely to have a meaningful impact upon fuel consumption during a long driving session.

Then, based on the combination of the retrieved values of the indicators for each of the identified events when applied together with the corresponding group of pre-determined coefficients, a score representing the driver's performance associated with a certain class (aspect) of the driver's driving performance may be calculated.

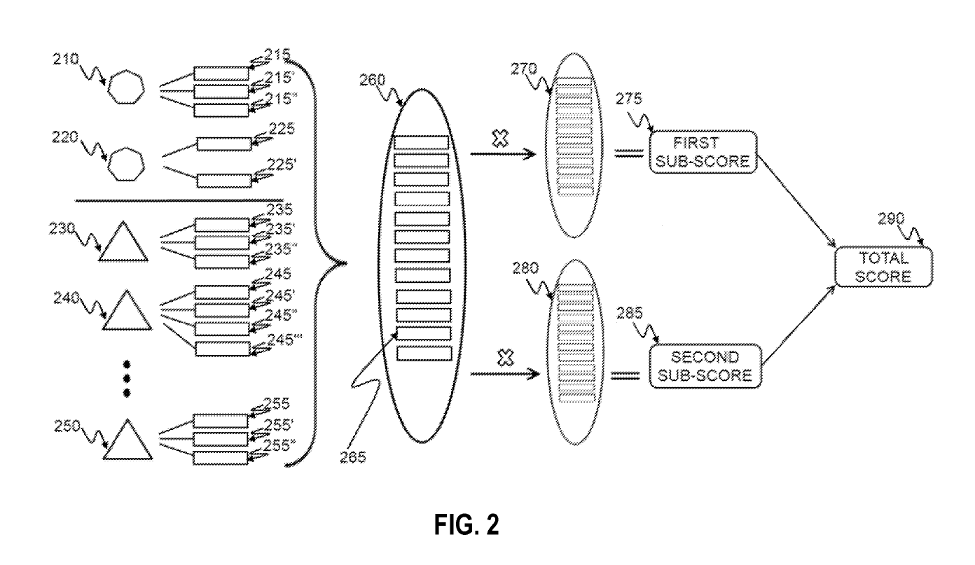

In the example illustrated in FIG. 2, a period of two driving sessions has been selected during which the driving performance should be evaluated. The first driving session is designated by 210 while the second driving session is designated by 220. During these two driving sessions, N driving events were identified, and these driving events may be classified into M different types of driving events (where M<N). 230 designates driving_event_{K=1}, 240—driving_event_{K=2} and 250 designates driving_event_{K=N}. In this example, driving_event_{K=1} and the driving_event_{K=N} designate driving events which are of the same type.

Each driving session and each identified driving event included therein are characterized by a plurality of indicators. Driving session 210 is characterized by indicators 215, 215′ and 215″, driving event 230 is characterized by indicators 235, 235′ and 235″ etc. Driving events 230 and 250 are characterized by the same indicators but of course the retrieved values of the respective indictors 235, 235′ and 235″ are not identical to the retrieved value of indicators 255, 255′, and 255″, as both these driving events 230 and 250 were driven somewhat differently.

The retrieved values of at least some of the indicators of the N identified driving events, are used to form indicators' group 260 and obtain a representative value for this group. The value of each member in the indicators' group is the aggregated result (or averaged result or any other applicable manipulation of the respective group) of the retrieved values of indicators associated with the same type of driving event. In the example illustrated in FIG. 2, as driving events 230 and 250 are of the same type, therefore indicator 235′ is of the same type as indicator 255′. 265 is the representative value of the indicator's group and its value is obtained by averaging the value of indicator 235′ and the value of indicator 255′. According to one embodiment, the indicators' group has the same number of members as the number of types of indicators (#members=M), and each member is associated with a certain type of indicator. In the alternative, the number of members of the indicators' group is lower than then the number of the types of indicators, since more than one type of indicators can contribute to create a member of the indicator group.

In this example the overall (total) score of a driver's driving performance is derived based on only two scores, each of which is associated with one aspect (class) of driving performance. However, as any one skilled in the art can appreciate, the method disclosed can easily be adapted to comprise three or more scores, each associated with one aspect of the driver's driving performance.

Examples for such possible other aspects of the driver's driving performance (i.e. other performance classes) may be found in the following:

1. driving skills class—this class may include for example the following indicators: proper use by the driver of the vehicle's transmission gear; proper use of signaling lights (e.g. does the driver use these lights properly before taking a turn, has the driver properly used them before changing a lane), etc.

2. completion of pre-defined tasks' class—this class may include for example the following indicators: for bus drivers, reaching bus stops on schedule; delivering merchandise on time to all specified customers, etc.

The first group of pre-determined coefficients 270 is associates with a first class of driving (e.g. eco driving), while the second group of pre-determined coefficients 280 is associates with the second class of driving (e.g. safe driving). According to one embodiment score 275 is determined by multiplying 260 and 270 and the result is normalized by the exposure (duration and/or distance) or by implementing any other mathematical transformation which is known per se. Similarly, score 285 is determined by multiplying 260 and 280 and normalizing the result thus obtained. Preferably each normalized score has a value between 0 and 1, but obviously this scale may be mathematically manipulated to provide 0 to 100, 1000 or any other value as required by the specific system, while each score represents the driver's driving performance according to one class (aspect) of his/her driving. According to another embodiment, the indicators' values themselves (215, 225, etc.) are multiplied by the performance class coefficients (270 or 280) to form the respective performance class score (e.g. score 275).

The score obtained for each class of driving performance may be presented separately (to the driver, to the fleet manager, etc.). In addition or in the alternative, the various scores are used to determine the overall score of the driver driving performance based on all classes evaluated, and the combined result is presented.

In addition, the user (e.g. the driver, the fleet manager, etc.) is capable to determine what weight will be given to each aspect of the driving performance when determining the total score 290 for the overall driving performance. For example the user can determine that in the present case, safety is the more important aspect, thus the total score may be:

Total_{score}=0.3·Score_{first}+0.7·Score_{second}

The score of the overall driving performance (or any of the one aspect driving performances) may be provided to the user, by any known communication channel (e.g. at a web site, by e-mail message, by SMS, in a smart phone display, etc.)

In addition or in the alternative, rather than calculate the score for each driving performance class, associate it with a certain weight and then determine the overall score for the driver based on the weighted scores, a certain weight may be associated with one or more (e.g. group) of indicators and multiplying them with their corresponding pre-defined coefficients, so that the score obtained for each driving performance class (and consequently the overall score) is affected by the weight given to the one or more indicators. For example, when the driving performance class is safety, a higher weight may be associated with indicators that are associated with braking than with indicators that are associated with backing.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present application has been described herein throughout the specification and claims with respect to the estimation of the driver's driving performance. However, as should be understood to any person of the art, the same method and system may be used for estimating driving performance associated with other entities, such as an organization unit (while taking into account driving performance of the various drivers belonging to that unit, or for estimating driving performance associated with a vehicle being driven by a plurality of drivers), etc.

Also, the present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method for evaluating driving performance of a driver according to one or more of at least two different performance classes, wherein each performance class relates to a different aspect of driving performance than the others, said method comprising:
identifying a plurality of driving events in one or more driving sessions, wherein each of the driving events is associated with one or more indicators characterizing the respective driving event;
retrieving values for indicators associated with the respective driving events identified;
providing a plurality of pre-defined coefficients that enable adapting the retrieved indicators' values to one of the at least two different performance classes; and
based on the values retrieved for the indicators associated with the identified driving events and the plurality of pre-defined coefficients, evaluating a driving performance that is compatible with one or more of said at least two different performance classes.

2. The method according to claim 1, wherein the pre-defined coefficients are operative to adapt the retrieved indicators' values to one of the at least two different performance classes, based upon the significance of the type of a driving event associated with the indicators being adapted, to the respective driving performance class.

3. The method according to claim 1, further comprising a step of dividing the indicators and/or the values thereof into groups, wherein at least one of these groups contains only one or more indicators and/or their values that are associated with one type of the identified driving events, and deriving a representative value for each of the indicators associated with the at least one group, wherein each representative value is derived based on the values of respective indicators included in that at least one group.

4. The method according to claim 1, wherein each of the at least two different classes of driving performance is associated with a corresponding set of a plurality of pre-defined coefficients.

5. The method according to claim 1, wherein one of the at least two different performance classes is safety and another one of the at least two different performance classes is economical driving.

6. The method according to claim 1, wherein the driving performance of the driver is an overall driving performance which is evaluated according to two or more different performance classes.

7. The method according to claim 6, wherein each of the two or more different performance classes is associated with a coefficient relative to the significance of that performance in the evaluation of the driver's overall driving performance.

8. The method according to claim 1, wherein the driving performance of the driver is evaluated for a pre-determined period of time.

9. The method according to claim 1, wherein the driving performance of the driver is evaluated for a pre-determined road section.

10. The method according to claim 1, wherein the value of at least one of the plurality of the pre-determined coefficients is affected by the specific vehicle being driven by the driver.

11. The method according to claim 1, wherein at least some of the plurality of pre-determined coefficients are associated with more than one value, and the value to be used is selected based upon at least one external factor which is not dependent on the driver's driving performance.

12. The method according to claim 1, wherein the step of retrieving values for indicators associated with the respective driving events identified, further comprises retrieving values for indicators that are associated with the one or more driving sessions but are not associated with any of the identified driving events.

13. A system for evaluating driving performance of a driver according to one or more of at least two different performance classes, wherein each performance class relates to a different aspect of driving performance than the others, said system comprising:
a plurality of sensors located within a vehicle being driven by the driver, operative to collect data that relates to the performance of a driver during one or more driving sessions; and
a processor adapted to:
identify a plurality of driving events in one or more driving sessions from among the data collected, wherein each of the driving events is associated with one or more indicators characterizing the respective driving event, and wherein the plurality of driving events identified comprises driving events of at least two different types;
based on the data collected by one or more of the plurality of sensors, retrieve values for indicators associated with each of the respective driving events identified;
based on the values retrieved for the indicators associated with the identified driving events, and a plurality of pre-defined coefficients used for adapting said retrieved indicators' values to one of the at least two different performance classes, evaluate a driving performance that is compatible with one or more of said at least two different performance classes.

14. The system according to claim 13, wherein said processor is configured to apply the pre-defined coefficients in order to adapt the retrieved indicators' values to one of the at least two different performance classes, based upon the significance of the type of the driving event associated with the indicators being adapted, to the respective driving performance class.

15. The system according to claim 13, wherein said processor is further configured to divide the indicators and/or the values thereof into groups, wherein at least one of these groups contains only one or more indicators and/or their values associated with one type of the identified driving events, and to derive therefrom a representative value for each of the indicators associated with the at least one group, wherein each representative value is derived based on the values of respective indicators included in that at least one group.

16. The system according to claim 13, wherein each of the at least two different classes of driving performance is associated with a corresponding set of a plurality of pre-defined coefficients.

17. The system according to claim 13, wherein the driving performance of the driver is an overall driving performance which is evaluated according to two or more different performance classes.

18. A computer program product encoding a computer program stored on a non-transitory computer readable storage medium for executing a set of instructions by a computer system comprising one or more computer processors for carrying out a method for evaluating a driving performance of a driver according to one or more of at least two different performance classes, wherein each performance class relates to a different aspect of driving performance than the others, the method comprising:
identifying a plurality of driving events in one or more driving sessions, wherein each of the driving events is associated with one or more indicators characterizing the respective driving event, and wherein the plurality of driving events identified comprises driving events of at least two different types;
retrieving values for indicators associated with the respective driving events identified; and
based on the values retrieved for the indicators associated with the identified driving events, and a plurality of pre-defined coefficients operative for adapting said retrieved indicators' values to one of the at least two different performance classes, evaluate a driving performance that is compatible with one or more of said at least two different performance classes.

19. The computer program product according to claim 18, wherein said pre-defined coefficients are operative to adapt the retrieved indicators' values to one of the at least two different performance classes, based upon the significance of the type of the driving event associated with the indicators being adapted, to the respective driving performance class.

20. The computer program product according to claim 18, wherein the driving performance of the driver is an overall driving performance which is evaluated according to two or more different performance classes.
